(19) United States
(12) Patent Application Publication
(10) Pub. No.: US 2023/0008337 A1
(43) Pub. Date: Jan. 12, 2023

(54) HEATING COOKER

(71) Applicant: SHARP KABUSHIKI KAISHA, Osaka (JP)

(72) Inventors: MASAYUKI IWAMOTO, Osaka (JP); Tomohiro KITAURA, Osaka (JP)

(21) Appl. No.: 17/860,497

(22) Filed: Jul. 8, 2022

(30) Foreign Application Priority Data
Jul. 12, 2021 (JP) 2021-115005

(51) Int. Cl. H05B 6/64

(52) U.S. Cl. CPC H05B 6/6411

(57) ABSTRACT

A heating cooker includes a drawer body, a turntable, a magnetron, and a rotor. The turntable is arranged in the drawer body. The magnetron heats a to-be-heated object Hm placed on the turntable. The rotor rotates the turntable. Power of the rotor acts on a side surface of the turntable.

### BACKGROUND OF THE INVENTION

### Field of the Invention

The present invention relates to a heating cooker.

### Description of the Background Art

Japanese Unexamined Patent Application Publication No. 2010-127561 discloses a drawer-type heating cooker. The drawer-type heating cooker disclosed in Japanese Unexamined Patent Application Publication No. 2010-127561 is provided with a heating cooker body, a drawer body, a rotary table, a drive gear, a sector gear, an output gear, and a motor. The heating cooker body includes a heat cooking compartment. The drawer body can be pulled out toward the outside of the heating cooker body from a state where the drawer body is housed in the heat cooking compartment. The rotary table is mounted in the center at the upper side of the drawer body. A rotation shaft fixed to the rotary table is disposed at the lower side of the rotary table. The drive gear for driving and rotating the rotary table is attached to the rotation shaft. The drive gear engages with the sector gear. The sector gear is swingable around a swing shaft. Additionally, the sector gear engages with the output gear. The motor is driven to rotate the output gear. The direction of output of the motor is reversed depending on a predetermined rotating speed, and thus the output gear allows the sector gear engaged with the output gear to swing within a predetermined swing angle. Then, the drive gear is reversely rotated, and thus the rotary table sequentially reversely rotates by a predetermined angle.

However, in the drawer-type heating cooker disclosed in Japanese Unexamined Patent Application Publication No. 2010-127561, in a case where a to-be-heated object is large, the to-be-heated object may not be placed on the rotary table (a turntable). In this case, the drawer-type heating cooker disclosed in Japanese Unexamined Patent Application Publication No. 2010-127561 cannot cook the to-be-heated object with heat.

The present invention is thus made in view of the problem above, and an object of the present invention is to provide a heating cooker that allows a turntable to be used and cooks a larger to-be-heated object with heat.

### SUMMARY OF THE INVENTION

A heating cooker according to an aspect of the present invention includes a drawer body, a turntable, a heater, and a rotor. The turntable is arranged in the drawer body. The heater heats a to-be-heated object placed on the turntable. The rotor rotates the turntable. Power of the rotor acts on a side surface of the turntable.

According to the aspect of the present invention, the turntable is usable, and a larger to-be-heated object can be cooked with heat.

### BRIEF DESCRIPTION OF THE DRAWINGS

FIG. 1 is a diagram illustrating the front side of a heating cooker according to an embodiment of the present invention.

FIG. 2A is a diagram illustrating the right side surface of the heating cooker according to the present embodiment.

FIG. 2B is a diagram illustrating the right side surface of the heating cooker according to the present embodiment.

FIG. 3 is a diagram illustrating a schematic cross-section of a heating cabinet according to the present embodiment.

FIG. 4 is a diagram illustrating a schematic cross-section of the heating cabinet according to the present embodiment.

FIG. 5A is a diagram illustrating the upper surface of a drawer body according to the present embodiment.

FIG. 5B is a diagram illustrating the upper surface of the drawer body according to the present embodiment.

FIG. 6A is an enlarged view illustrating an example of a rotor and a turntable according to the present embodiment.

FIG. 6B is an enlarged view illustrating another example of the rotor and the turntable according to the present embodiment.

### DESCRIPTION OF THE PREFERRED EMBODIMENTS

Hereinafter, embodiments of a drawer-type heating cooker according to the present invention will be described with reference to the drawings. Note that, in the drawings, identical or equivalent portions are designated by the same reference numbers and explanations are not repeated.

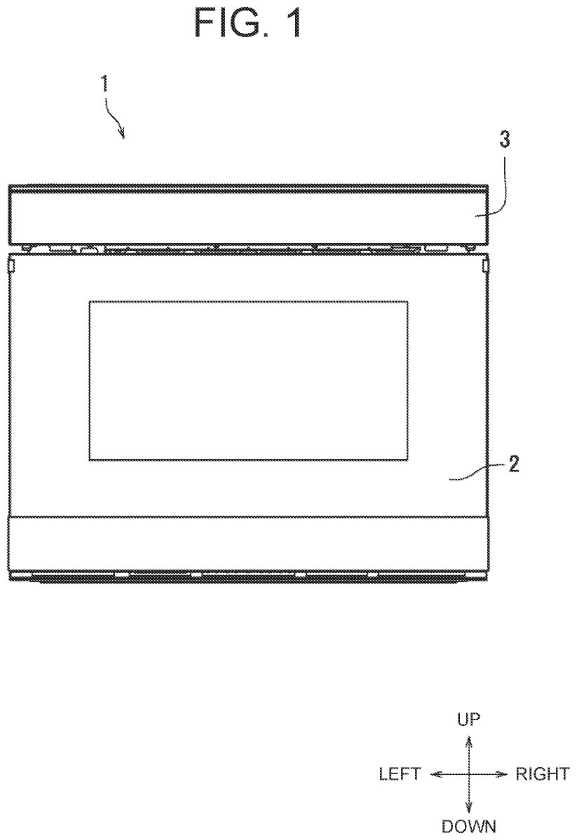

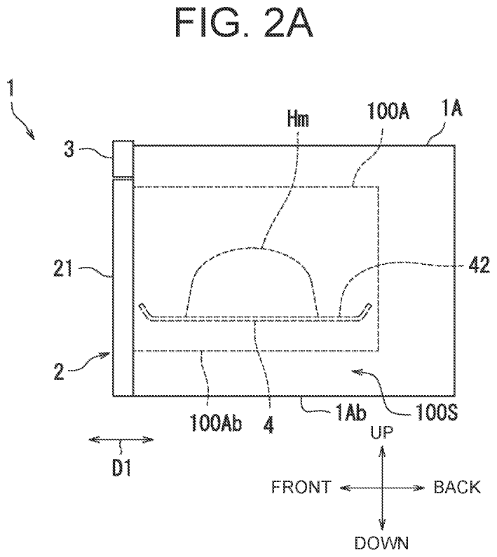

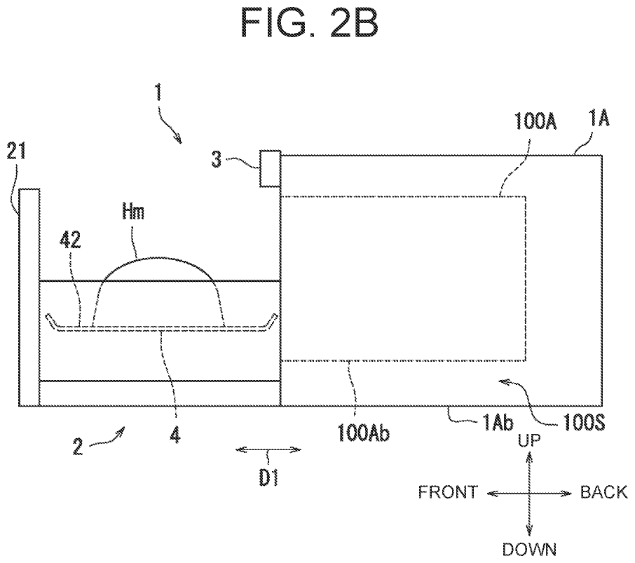

A heating cooker 1 according to the present embodiment will be described with reference to FIGS. 1, 2A, and 2B. FIG. 1 is a diagram illustrating the front side of the heating cooker 1 according to the present embodiment. FIGS. 2A and 2B are diagrams illustrating the right side surface of the heating cooker 1. Specifically, FIG. 2A illustrates the heating cooker 1 in a state where a drawer body 2 is housed in a heat cooking compartment 100A. FIG. 2B illustrates the heating cooker 1 in a state where the drawer body 2 is pulled out from the heat cooking compartment 100A.

The heating cooker 1 cooks a to-be-heated object Hm with heat. The to-be-heated object Hm is, for example, a food product. As illustrated in FIG. 1, the heating cooker 1 includes the drawer body 2 and an operation panel 3. In other words, the heating cooker 1 of the present embodiment is a drawer-type heating cooker. Additionally, as illustrated in FIGS. 2A and 2B, the heating cooker 1 further includes a heating cabinet 1A and a turntable 4.

In the present embodiment, the side on which the operation panel 3 of the heating cooker 1 is disposed is defined as the front side (front surface side) of the heating cooker 1, and the opposite side thereof is defines as the back side of the heating cooker 1. Further, the right side viewed from the front side of the heating cooker 1 is defined as the right side of the heating cooker 1, and the opposite side thereof is defined as the left side of the heating cooker 1. Furthermore, in a direction orthogonal to a front-back direction and a left-right direction of the heating cooker 1, the side on which the operation panel 3 is disposed is defined as the upper side of the heating cooker 1, and the opposite side thereof is defined as the lower side of the heating cooker 1. Note that these directions do not limit directions when the heating cooker 1 of the present invention is in use.

The heating cabinet 1A is a box-shaped member. The heating cabinet 1A includes therein the heat cooking compartment 100A. The heat cooking compartment 100A has, for example, a substantially cuboid shape. The material of the heat cooking compartment 100A is, for example, metal. The front side of the heat cooking compartment 100A is opened to pull out/in the to-be-heated object Hm. In addition, the heating cabinet 1A includes a space 100S between a bottom wall 1Ab of the heating cabinet 1A and a bottom wall 100Ab of the heat cooking compartment 100A. The space 100S is located below the heat cooking compartment 100A. The space 100S will be described below.

The drawer body 2 can be pulled out along a first direction D1 with respect to the heat cooking compartment 100A. The first direction D1 extends along the front-back direction. Specifically, the drawer body 2 can be pulled out with respect to the heat cooking compartment 100A and can be pulled in with respect to the heat cooking compartment 100A. In other words, the drawer body 2 can be pulled out with respect to the heating cabinet 1A and can be pulled in with respect to the heating cabinet 1A.

The drawer body 2 includes a door 21. The door 21 can open and close the front side opening of the heat cooking compartment 100A. The door 21 is a plate-shaped member having a substantially rectangular shape. As illustrated in FIG. 2A, the door 21 closes the front side opening of the heat cooking compartment 100A in a state where the drawer body 2 is pulled into the heat cooking compartment 100A. Further, as illustrated in FIG. 2B, the door 21 opens the front side opening of the heat cooking compartment 100A in a state where the drawer body 2 is pulled out from the heat cooking compartment 100A.

The turntable 4 is arranged in the drawer body 2. The material of the turntable 4 is, for example, heat-resistant glass or ceramics. For example, the to-be-heated object Hm is placed on the turntable 4. Specifically, the to-be-heated object Hm is placed on a main surface 42 of the turntable 4. As illustrated in FIG. 2A, the turntable 4 is disposed inside the heat cooking compartment 100A in a state where the drawer body 2 is pulled into the heat cooking compartment 100A. Furthermore, as illustrated in FIG. 2B, the turntable 4 is disposed outside the heat cooking compartment 100A in a state where the drawer body 2 is pulled out from the heat cooking compartment 100A.

The operation panel 3 is located at an upper portion on the front surface of the heating cabinet 1A. The operation panel 3 includes, for example, an operation part and a display. The operation part receives an operation from a user. The operation part includes various keys. The display displays a variety of information. The display includes a liquid crystal panel.

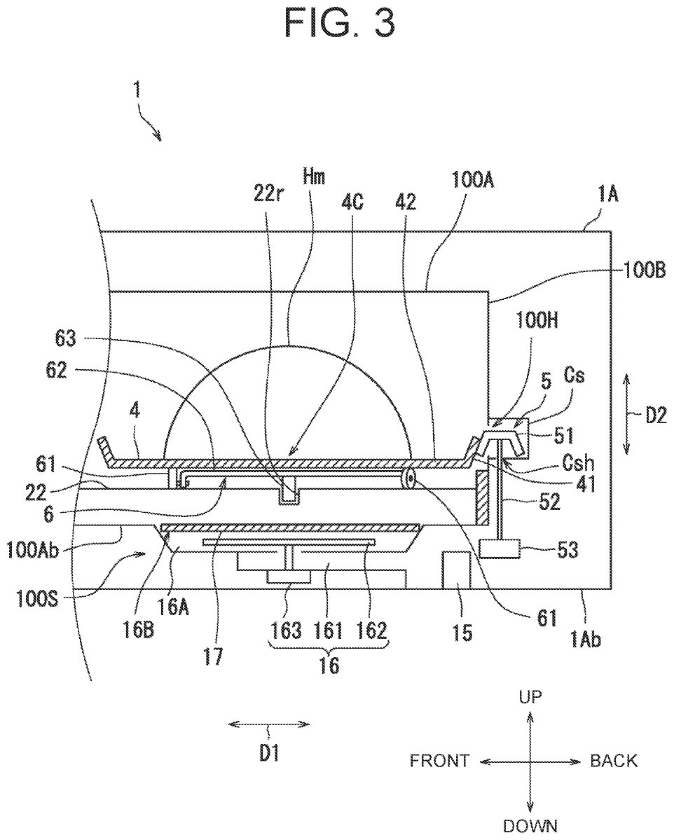

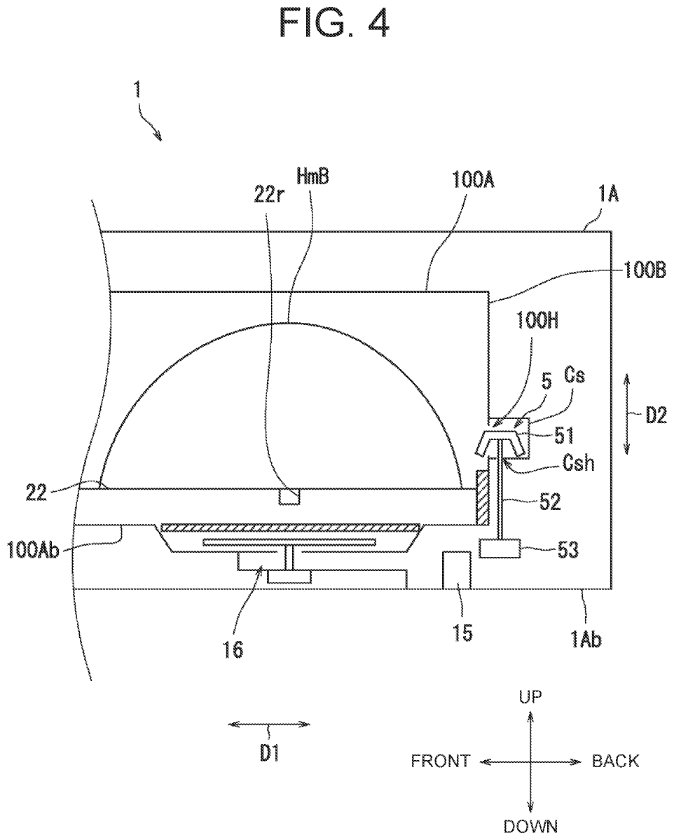

Next, the heating cabinet 1A according to the present embodiment will be further described with reference to FIGS. 3 and 4. FIGS. 3 and 4 are diagrams each illustrating a schematic cross-section of the heating cabinet 1A according to the present embodiment. Specifically, FIGS. 3 and 4 illustrate a cross-section of the heating cabinet 1A cut along a plane orthogonal to the left-right direction. Also, the drawer body 2 illustrated in FIGS. 3 and 4 is pulled into the heat cooking compartment 100A. In addition, the to-be-heated object Hm illustrated in FIG. 3 has a size that can be placed on the turntable 4. Meanwhile, a to-be-heated object Hmb illustrated in FIG. 4 has a size that cannot be placed on the turntable 4. In other words, the to-be-heated object Hmb is larger than the to-be-heated object Hm.

As illustrated in FIG. 3, the heating cooker 1 further includes a rotor 5. The rotor 5 rotates the turntable 4. In the present embodiment, power of the rotor 5 acts on a side surface 41 of the turntable 4. Therefore, even when the rotor is not disposed below the turntable, the turntable 4 can be rotated. As a result, for example, a stirrer 16 or the like that stirs microwaves can be disposed below the turntable 4, and thus the to-be-heated object Hm can be cooked with heat by placing the to-be-heated object Hm on the turntable 4 or by removing the turntable 4 from the drawer body 2 and placing the to-be-heated object Hm directly on the drawer body 2. In other words, the larger to-be-heated object Hmb can be cooked with heat while the turntable 4 is usable. Removal of the turntable 4, and the stirrer 16 will be described below.

In the present embodiment, the rotor 5 is disposed extending through a side surface 100B of the heat cooking compartment 100A. Specifically, the rotor 5 is disposed extending through an opening 100E1 included in the side surface 100B of the heat cooking compartment 100A. Accordingly, since a rotation shaft of the rotor 5 can be disposed outside the heat cooking compartment 100A, the rotation shaft of the rotor 5 can be disposed outside the drawer body 2. As a result, the drawer body 2 can be pulled out from the heat cooking compartment 100A without pulling out the rotor 5. In addition, since power source of the rotor 5 can be disposed outside the drawer body 2, a configuration in which the turntable and the rotor are connected in the up-down direction is not required, and even when the heating cooker 1 is a drawer-type heating cooker, the turntable 4 is usable.

The side surface 100B including the opening 10011 is preferably located at a rear portion of the heat cooking compartment 100A. In other words, the opening 10011 is preferably located at the rear portion of the heat cooking compartment 100A. Therefore, at the time of pulling out the drawer body 2 from the heat cooking compartment 100A or puling the drawer body 2 into heat cooking compartment 100A, the rotor 5 and the turntable 4 can be prevented from interfering with each other.

Further, in the present embodiment, the rotor 5 comes into contact with the side surface 41 of the turntable 4. Specifically, the rotor 5 is provided with a roller 51, a shaft 52, and a motor 53. The roller 51 is mounted on a tip end of the shaft 52. In the present embodiment, the motor 53 rotates the shaft 52. In other words, the motor 53 rotates the roller 51 via the shaft 52. That is, the shaft 52 functions as the rotation shaft of the rotor 5. In a state where the drawer body 2 is pulled into the heat cooking compartment 100A, the roller 51 is in contact with the side surface 41 of the turntable 4. Therefore, the turntable 4 can be rotated without placing a component different from the rotor 5 and the turntable 4 between the rotor 5 and the turntable 4. As a result, the number of components can be reduced.

Furthermore, the heating cabinet 1A further includes therein a storage chamber Cs. The storage chamber Cs is in communication with the heat cooking compartment 100A through the opening 10011 of the heat cooking compartment 100A. The storage chamber Cs is fixed. The storage chamber Cs has, for example, a substantially cuboid shape. The material of the storage chamber Cs is, for example, metal. The roller 51 of the rotor 5 is housed in the storage chamber Cs. The storage chamber Cs is smaller than the heat cooking compartment 100A. Note that the storage chamber Cs is preferably as small as possible to house the roller 51. This is because the heating cooker 1 can be downsized

The storage chamber Cs includes an opening Csh. The shaft 52 of the rotor 5 extends through the opening Csh. The opening Csh has, for example, a size that allows for rotation of the shaft 52 and does not allow for leakage of microwaves.

The drawer body 2 further includes a placing section 22. The placing section 22 is a plate-shaped member. The material of the placing section 22 is, for example, ceramics, glass, or synthetic resin. Therefore, the placing section 22 allows penetration of microwaves. Additionally, the placing section 22 is, for example, transparent or translucent. Translucency includes colored transparency.

The heating cooker 1 further includes a roller stay 6. The roller stay 6 is rotatably disposed on the placing section 22. The roller stay 6 supports the turntable 4. The roller stay 6 is an example of a “support portion”.

The roller stay 6 includes a plurality of rollers 61, a plurality of stays 62, and an engagement portion 63. The rollers 61 are respectively attached to tip ends of the plurality of stays 62. Also, the engagement portion 63 is connected to base ends of the plurality of stays 62. The engagement portion 63 has, for example, a substantially cylindrical shape. The engagement portion 63 is disposed opposed to a central portion 4C of the turntable 4 in a second direction D2 intersecting with the first direction D1. The second direction D2 extends along the up-down direction. The engagement portion 63 detachably engages with the drawer body 2. Specifically, the engagement portion 63 detachably engages with a recess 22r included in the placing section 22. As a result, the turntable 4 and the roller stay 6 are detachable with respect to the drawer body 2. For example, as illustrated in FIG. 4, the turntable 4 and the roller stay 6 can be detached from the drawer body 2. In a case where the turntable 4 and the roller stay 6 are detached from the drawer body 2, the to-be-heated object Hm can be directly placed on the placing section 22. In other words, the to-be-heated object Hmb larger than the to-be-heated object Hm can be placed on the placing section 22.

In the present embodiment, the roller stay 6 includes the three rollers 61 and the three stays 62. Note that in FIG. 3 only the two rollers 61 and two stays 62 are illustrated for simplification of the drawing. However, the roller stay 6 may include two rollers 61 and two stay 62 or may include four or more rollers 61 and four or more stays 62. Each of the plurality of rollers 61 fits into a groove (not illustrated) included in a bottom surface of the turntable 4.

The power of the rotor 5 acts on the side surface 41 of the turntable 4, and thus the roller stay 6 (the plurality of rollers 61) rotates about the engagement portion 63 as a rotation axis. As a result, the turntable 4 rotates about the engagement portion 63 as the rotation axis. In a case where the power of the rotor 5 continues to act in one direction on the side surface 41 of the turntable 4, the turntable 4 continues to rotate in one direction. In other words, the turntable 4 can rotate 360°. Therefore, uneven heating of the to-be-heated object Hm placed on the turntable 4 can be suppressed compared to a case where the turntable sequentially reverses and switches the rotating direction every time the turntable rotates by a predetermined angle (in other words, a case where the turntable swings).

Also, the heating cooker 1 further includes a magnetron 15, the stirrer 16, and a partitioning member 17. The magnetron 15 and the stirrer 16 are located via the bottom wall 100Ab outside the heat cooking compartment 100A.

The magnetron 15 generates microwaves. In other words, the magnetron 15 supplies microwaves into the heat cooking compartment 100A. For example, the to-be-heated object Hm (to-be-heated object Hmb) is heated by the microwaves generated by the magnetron 15. The magnetron 15 is an example of a “heater”. The stirrer 16 includes a radiation chamber 16A, a waveguide 161, a rotation antenna 162, and an antenna motor 163.

The radiation chamber 16A includes a radiation port 16B through which the microwaves are irradiated into the heat cooking compartment 100A. When the radiation port 16B is viewed from above, the shape of the radiation port 16B is, for example, a square. In addition, the radiation port 16B is located below the heat cooking compartment 100A. Specifically, the radiation port 16B is located approximately in the center of the bottom wall 100Ab. The rotation antenna 162 is housed in the radiation chamber 16A. The antenna motor 163 drives the rotation antenna 162. The rotation antenna 162 stirs the microwaves and supplies the microwaves through the radiation port 16B into the heat cooking compartment 100A.

The waveguide 161 is located below the heat cooking compartment 100A. The waveguide 161 guides the microwaves from the magnetron 15 to the radiation port 16B. As described above, the heating cabinet 1A includes the space 100S located below the heat cooking compartment 100A, and thus the stirrer 16 can be disposed below the heat cooking compartment 100A. As a result, even in a case where the to-be-heated object Hm (to-be-heated object Hmb) is directly placed on the drawer body 2, the to-be-heated object Hm (to-be-heated object Hmb) can be heated while uneven heating is suppressed.

Additionally, the partitioning member 17 covers the radiation port 16B. The partitioning member 17 may have any shape that can cover the radiation port 16B. The partitioning member 17 is preferably a plate-shaped member. Also, when viewed in the up-down direction, the shape of the partitioning member 17 is, for example, a square shape.

The material of the partitioning member 17 includes, for example, ceramics or glass. As a result, the material of the partitioning member 17 includes ceramics or glass, and thus the partitioning member 17 allows penetration of microwaves. Meanwhile, the materials of the radiation chamber 16A and the waveguide 161 include metal.

In the present embodiment, the rotor 5 rotates the turntable 4 while the heating cooker 1 is cooking the to-be-heated object Hm with heat, that is, while the magnetron 15 is generating microwaves. Note that in the present embodiment, even in a case where the turntable 4 is placed in the drawer body 2 or even in a case where the turntable 4 is removed from the drawer body 2, the rotor 5 rotates the turntable 4 while heating cooker 1 is cooking the to-be-heated object Hm with heat. However, in a case where the turntable 4 is removed from the drawer body 2, the rotor 5 does not have to rotate the turntable 4. A user may input information via the operation panel 3 on whether the turntable 4 is removed from the drawer body 2.

Alternatively, the heating cooker 1 may be provided with a detection unit that detects whether the turntable 4 is removed from the drawer body 2. Then, based on the information input from the user or the detection results of the detection unit, a control unit (not illustrated) included in the heating cooker 1 drives the motor 53 of the rotor 5.

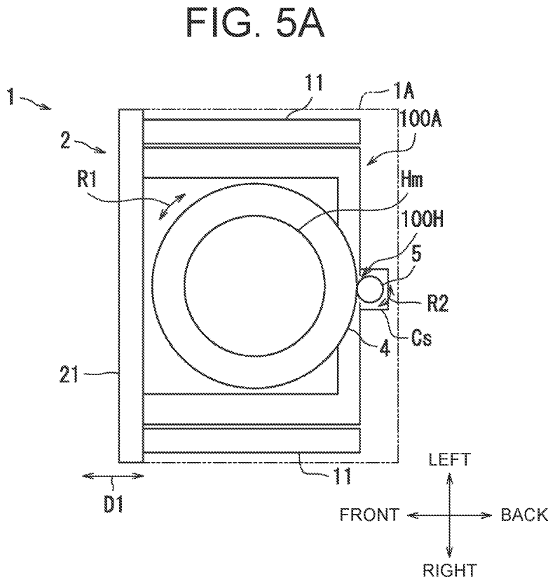

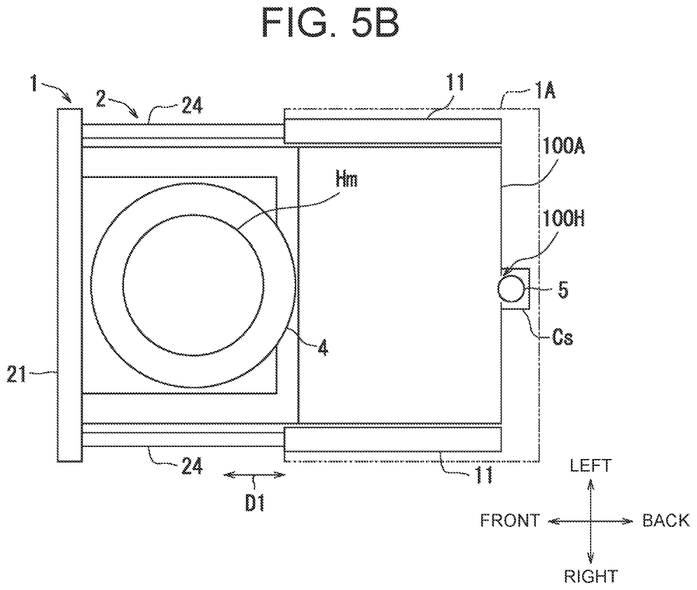

Next, the drawer body 2 according to the present embodiment will be described with reference to FIGS. 5A and 5B. FIGS. 5A and 5B are diagrams each illustrating the upper surface of the drawer body 2 according to the present embodiment. Specifically, FIG. 5A illustrates the drawer body 2 housed in the heating cabinet 1A. FIG. 2B illustrates the drawer body 2 pulled out from the heating cabinet 1A.

The drawer body 2 further includes a pair of sliding members 24. Each of the pair of sliding members 24 is, for example, a member having a longitudinal direction in the front-back direction. The pair of sliding members 24 are opposed to each other in the left-right direction. The pair of sliding members 24 restrict the moving direction of the drawer body 2 in the front-back direction. The pair of sliding members 24 are respectively fixed to both edge portions on an inner surface of the door 21.

Meanwhile, the heating cabinet 1A further includes a pair of slide rails 11. The pair of slide rails 11 are fixed inside the heating cabinet 1A. The pair of slide rails 11 are each a member having a longitudinal direction in the front-back direction. The pair of sliding members 24 are slidably supported by the pair of slide rails 11, respectively.

As illustrated in FIG. 5A, in a state where the drawer body 2 is housed in the heat cooking compartment 100A, the pair of sliding members 24 are respectively located inside the pair of slide rails 11. Meanwhile, as illustrated in FIG. 5B, in a state where the drawer body 2 is pulled out from the heat cooking compartment 100A, the pair of sliding members 24 are respectively pulled out from the pair of slide rails 11.

Also, as illustrated in FIG. 5A, in a state where the drawer body 2 is housed in the heating cabinet 1A, the turntable 4 is in contact with the rotor 5. In other words, the turntable 4 rotates in a rotation direction R1 in accordance with rotation of the rotor 5 in a rotation direction R2. Meanwhile, as illustrated in FIG. 5B, in a state where the drawer body 2 is pulled out from the heating cabinet 1A, the rotor 5 is fixed and does not move. Therefore, even when the rotor is not disposed below the turntable, the turntable 4 can be rotated.

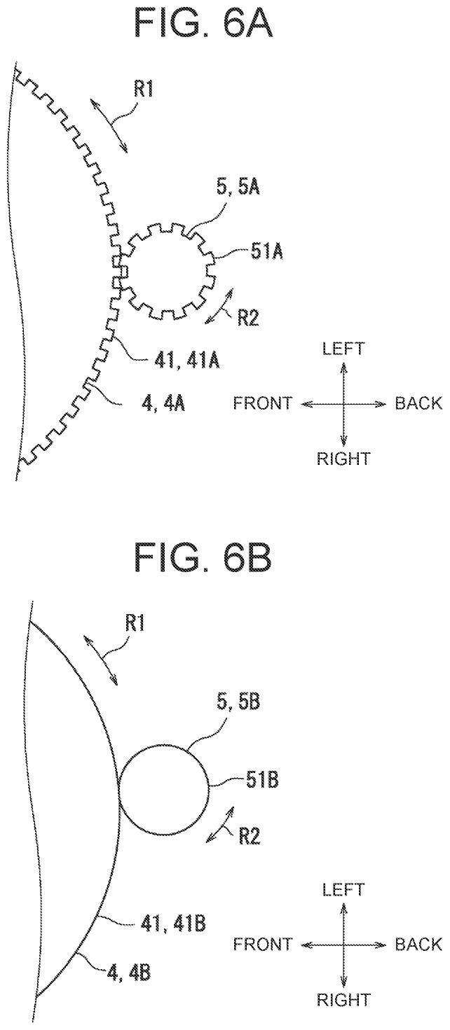

Next, the rotor 5 will be described with reference to FIGS. 6A and 6B. First, a case where the rotor 5 is a gear will be described with reference to FIG. 6A. FIG. 6A is an enlarged view illustrating an example of the rotor 5 and the turntable 4 according to the present embodiment.

As illustrated in FIG. 6A, the side surface 41 of the turntable 4 includes, for example, recesses and protrusions. Hereafter, the turntable 4 with the side surface 41 including recesses and protrusions may be described as a turntable 4A, and the side surface 41 may be described as a side surface 41A.

Also, the rotor 5 includes recesses and protrusions. Hereinafter, the rotor 5 including recesses and protrusions may be described as a rotor 5A. Specifically, a roller 51A of the rotor 5A includes recesses and protrusions. In other words, the roller 51A is, for example, a gear. Therefore, the side surface 41A of the turntable 4A engages with the roller 51A to rotate with each other. As a result, the turntable 4A rotates at a stable speed, and uneven heating of the to-be-heated object Hm can be more effectively suppressed. Here, the material of the roller 51A is, for example, heat resistant resin. Note that the material of the roller 51A may be metal such as enamel.

Additionally, as illustrated in FIG. 6B, the side surface 41 of the turntable 4 is, for example, a smooth surface. Hereinafter, the turntable 4 including the side surface 41 that is a smooth surface may be described as a turntable 4B, and the side surface 41 may be described as a side surface 41B. Note that, the side surface 41B does not have to be a completely smooth surface. For example, the side surface 41B may be rough.

Also, the side surface of the rotor 5 is a smooth surface. Hereinafter, the rotor 5 including the side surface that is a smooth surface may be described as a rotor 5B. Specifically, a side surface of a roller 51B of the rotor 5B is a smooth surface. Note that, the roller 51B does not have to have a completely smooth surface. For example, the roller 51B may be rough. Thus, wear of the turntable 4B and the rotor 5B can be suppressed. Here, the material of the roller 51B is, for example, heat resistant silicon.

As described above, the embodiments of the present invention are described with reference to the drawings. However, the present invention is not limited to the aforementioned embodiments and can be carried out in various modes without departing from the scope of the present invention. The drawings mainly and schematically illustrate components for ease of comprehension, and the thickness, length, number, etc. of each of the illustrated components are different from the actual ones for convenience of drawing creation. Additionally, the material, shape, dimensions, etc. of each component illustrated in the aforementioned embodiments are merely examples, and are not particularly limited. Various changes can be made substantially without departing from the effects of the present invention.

(1) As described with reference to FIG. 3, the rotor 5 is brought into contact with the side surface 41 of the turntable 4 in the present embodiment. Note that as long as the power of the rotor 5 acts on the side surface 41 of the turntable 4, the rotor 5 does not have to be in contact with the side surface 41 of the turntable 4. For example, a different member from the rotor 5 and the turntable 4 may be disposed between the rotor 5 and the turntable 4. Specifically, at least a roller or the like may be disposed between the rotor 5 and the side surface 41.

(2) As described with reference to FIG. 3, the rotor 5 is disposed extending through the side surface 100B of the heat cooking compartment 100A, which is located at the rear side. Note that as long as the power of the rotor 5 acts on the side surface 41 of the turntable 4, the rotor 5 may be disposed extending through a side surface of the heat cooking compartment 100A, which is located at the right or left side.

(3) The heating cooker 1 may further include a blower that supplies hot air into the heat cooking compartment 100A.

(4) The heating cooker 1 may further include a grill. The grill includes, for example, a heater and a current-carrying portion. The heater is located in the heat cooking compartment 100A to heat the to-be-heated object Hm. The heater is, for example, a sheathed heater. The current-carrying portion energizes the heater. The energized heater generates heat.

(5) As described with reference to FIGS. 3 and 4, the large to-be-heated object Hmb is placed on the placing section 22 in a state where the turntable 4 and the roller stay 6 are removed from the drawer body 2. Note that, the small to-be-heated object Hm may be placed directly on the placing section 22.

The present invention includes industrial applicability and is useful, for example, in the field of heating cookers.

What is claimed is:

1. A heating cooker, comprising:
a drawer body;
a turntable arranged in the drawer body;
a heater that heats a to-be-heated object placed on the turntable; and
a rotor that rotates the turntable,
wherein power of the rotor acts on a side surface of the turntable.

2. The heating cooker according to claim 1,
wherein the rotor is brought into contact with the side surface of the turntable.

3. The heating cooker according to claim 1, further comprising a heat cooking compartment into which the drawer body can be pulled,
wherein the rotor is disposed extending through a side surface of the heat cooking compartment.

4. The heating cooker according to claim 1, further comprising a stirrer that stirs microwaves to be supplied into the drawer body by the heater.

5. The heating cooker according to claim 1, further comprising a support portion that supports the turntable,
wherein the support portion includes an engagement portion engageable with the drawer body, and
the engagement portion is located opposed to a central portion of the turntable in a direction intersecting with a direction in which the drawer body is pulled out.

6. The heating cooker according to claim 1,
wherein the side surface of the turntable includes recesses and protrusions, and
the rotor includes recesses and protrusions.

7. The heating cooker according to claim 1,
wherein the side surface of the turntable is a smooth surface, and a side surface of the rotor is a smooth surface.
